(19) United States
(12) Patent Application Publication
(10) Pub. No.: US 2022/0238952 A1
(43) Pub. Date: Jul. 28, 2022

(54) BATTERY DEVICE FOR A VEHICLE

(71) Applicants: AVL List GmbH, Graz (AT); Daimler AG, Stuttgart (DE)

(72) Inventors: Ales POLIC, Lenart (SI); Fabian LUTTENBERGER, Graz (AT); Michael Rudolf REITER, Ehrenhausen an der Weinstrasse (AT); Albert BEICHTBUCHNER, St. Lorenzen im Mürztal (AT); Takeshi SHIMONAGATA, Kawasaki, Kanagawa (JP); Vikram MENON, Kawasaki, Kanagawa (JP); Markus UHL, Kawasaki, Kanagawa (JP)

(73) Assignees: AVL List GmbH, Graz (AT); Daimler AG, Stuttgart (DE)

(21) Appl. No.: 17/613,967

(22) PCT Filed: May 22, 2020
(86) PCT No.: PCT/AT2020/060208

§ 371 Date: Nov. 24, 2021

(30) Foreign Application Priority Data
May 24, 2019 (DE) 10 2019 113 917.1

(51) Int. Cl. H01M 50/269; H02J 7/00; H02J 9/06; H01M 50/512; H01M 50/204; H01M 50/249; H01M 10/48

(52) U.S. Cl. CPC H01M 50/269; H02J 7/0013; H02J 9/06; H02J 7/0031; B60L 50/66; H01M 50/204; H01M 50/249; H01M 10/482; H01M 2220/20; H01M 50/512

(57) ABSTRACT

The invention relates to a battery device (10) for a vehicle, having a main battery system (20) with at least two battery units (BS) and an emergency battery system (30) with at least one battery unit (BS), wherein the main battery system (20) has more battery units (BS) than the emergency battery system (30), wherein the main battery system (20) and the emergency battery system (30) furthermore have the same nominal voltage and are electrically connected in parallel with one another, and the main battery system (20) has a main switch (22) for disconnecting the main battery system (20) and the emergency battery system (30) has an emergency switch (32), separate from the main switch (22), for disconnecting the emergency battery system (30).

The present invention relates to a battery device for a vehicle and a method for monitoring such a battery device.

It is known for vehicles to be equipped with battery devices in order in particular to ensure or support the drive of the vehicle. Such vehicles are also known as electric vehicles or as hybrid vehicles. The present invention relates in particular to purely electrically driven vehicles in which the battery device is the sole possibility for storing drive energy.

Known battery devices suffer from a fundamental disadvantage in the event of a defect within the battery device. Known battery devices are usually composed of a plurality of individual battery units. Each of these battery units usually comprises individual battery modules arranged in layers. These battery modules are in turn each equipped with a specific defined number of battery cells which represent the smallest energy storage unit of the battery device. However, due to the interconnections within the battery unit and thus within the battery device, a defect in an individual battery cell and/or in an individual battery module leads to a general failure of the entire battery device. Thus, there are great number of possible defects which can lead to a general electrical defect in the battery device. An electric vehicle which relies exclusively on the electrical energy within the battery device in order to provide locomotion via an electric motor thus suffers from numerous defect risks. The defect in a battery cell can be caused by mechanical action as well as by the ageing process of the battery device and in particular of the individual battery cells. In known vehicles, this means that a single defective battery cell leads to a breakdown of the vehicle and thus to a defective battery device. In the event of such a defect, the vehicle will need to be towed by external means, for example by a tow truck. In the event of such a defect it is no longer possible for the vehicle to move under its own power.

It is the object of the present invention to remedy, at least in part, the disadvantages described above. In particular, it is the object of the present invention to ensure the mobility of a vehicle in a cost-effective and simple manner, even with a defective battery cell.

The above object is achieved by a battery device with the features of claim 1 and a method with the features of claim 9. Further features and details of the invention arise from the dependent claims, the description and the drawings. Naturally, features and details which are described in connection with the battery device according to the invention also apply in connection with the method according to the invention and vice versa, so that with regard to the disclosure, mutual reference is or can always be made to the individual aspects of invention.

A battery device for a vehicle according to the invention has a main battery system with at least two battery units and an emergency battery system with at least one battery unit. The main battery system has in every case more battery units than the emergency battery system. Furthermore, the main battery system and the emergency battery system are electrically connected in parallel with one another and have the same nominal voltage. The main battery system and the emergency battery system therefore together form a part of an electrical circuit. Furthermore, the main battery system is equipped with a main switch for disconnecting the battery system, in particular from the described electrical circuit. The emergency battery system is equipped with an emergency switch, separate from the main switch, for disconnecting the emergency battery system from this electrical circuit.

Because the main battery system and the emergency battery system have the same nominal voltage, it is possible to connect these electrically with one another, directly, in parallel. The individual battery units can be self-contained production modules, the number of which is varied depending on the intended use. For example, a battery unit can be formed by a car battery. If a use in a truck is desired, the necessary greater capacity can be achieved simply by parallel connection of several such car batteries.

According to the invention, a parallel connection of two battery systems, namely the main battery system and the emergency battery system, is thus provided in a common electrical circuit. Each of these two parts, i.e. the emergency battery system and the main battery system, is equipped with its own switch as a switching device, which in the case of the main battery system is the main switch and in the case of the emergency battery system is the emergency switch. This leads to separate switching functionalities in the different applications, as will be explained in more detail below.

In comparison with known vehicles, a defect in the battery device can also occur in vehicles equipped with a battery device according to the invention. This can, for example, arise from a defective individual battery cell and/or a defective individual battery module. In the event of such a defect, all battery units within such a battery system, i.e. in the main battery system or in the emergency battery system, would no longer be available for the output of power in an electrical manner. A distinction can be made here between two basic defect scenarios.

In the first defect scenario, the defect exists within the emergency battery system. This means that a defect in the battery cell or in a battery module occurs within the at least one battery unit of the emergency battery system, and thus the emergency battery system is no longer able to output power. After detecting such a defect and localising this in the emergency battery system, the emergency battery system can be disconnected from the electrical circuit with the aid of the emergency switch. In other words, the main battery system is now available to supply the vehicle with electrical power. However, due to the fact that the main battery system is designed to be larger than the emergency battery system, there is a high probability that sufficient power is still available to drive the vehicle to a workshop or home. In the case of a defect affecting the emergency battery system, the mobility of the vehicle is therefore guaranteed.

As a second defect scenario, the defect can also occur within the main battery system. This means that a battery cell or a battery module in the main battery system is defective, which means that the main battery system is no longer able to supply corresponding electrical power to the vehicle for its operation. In such a case, after the defect has been detected and localised in the main battery system, the main switch disconnects the main battery system from the electrical circuit. The vehicle is now no longer connected with the main battery system but, in contrast to the known solutions, the emergency battery system is still functionally available within the electrical circuit to provide electrical energy for the vehicle, at least with reduced power output. Although the emergency battery system is smaller than the main battery system, the energy available in the emergency battery system is in any case sufficient for a so-called “limp home” function, i.e. to provide a residual mobility allowing the vehicle to be moved to a workshop, home or into another safe situation.

In the above descriptions of the two alternative defect situations in the main battery system and in the emergency battery system, it can be recognised that in both cases a residual mobility is provided. In both defect situations, this residual mobility is sufficient to enable the vehicle to be driven home and/or moved into a safe location. This is also known as the “limp home” function.

According to the invention, the emergency battery system is smaller than the main battery system.

This brings decisive advantages in addition to the basic function of securing the mobility of the vehicle. This can be seen in particular from the separate emergency switch, since this can be designed to be smaller, in terms of its electrical design, weight, price, but also its geometric size if the emergency battery system is designed to be correspondingly smaller than the main battery system. Thus, it should be pointed out that a core concept according to the invention is precisely this asymmetric design of the main battery system and the emergency battery system. In contrast to solutions which simply duplicate a main battery system, an asymmetric design according to the invention means that the emergency battery system can provide the “limp home” functionality in a more cost-effective way. This more cost-effective design is based in particular on the asymmetric design, since a smaller size and a lower capacity of the emergency battery system are also associated with a lower capacity and thus with lower costs and a smaller size of the emergency switch and the corresponding coupling into the electrical circuit.

It can bring advantages if, in a battery device according to the invention, the emergency battery system has exactly one battery unit. With this embodiment, the emergency battery system is defined to its minimum size. Consequently, the emergency battery system also allows only a minimal residual mobility, so that this exactly one battery unit is preferably designed for corresponding residual mobility, for example with regard to the distance the vehicle can travel. For example, the exactly one battery unit of the emergency battery system may be designed in such a way that, under certain defined conditions, it provides a residual mobility of for example a 50 km radius of movement for the vehicle. This residual mobility can also correlate with further limitations in the mobility of the vehicle, for example with a reduced acceleration capability and a reduced maximum speed, in order to be able, with high probability, to achieve this residual mobility in the form of the 50 km, even under adverse circumstances. The reduction in the design of the emergency switch can also be improved even further in this way. The voltage in the emergency battery system with exactly one battery unit as well as with several battery units preferably corresponds to the voltage in the battery units of the main battery system.

Further advantages can be achieved if, in a battery device according to the invention, the main battery system and the battery units of the emergency battery system are electrically identical or substantially electrically identical. In other words, a modular structure of the entire battery device can be provided. Each individual battery module is equipped with a defined and in particular identical number of identical battery cells.

Each battery unit is equipped with an identical number of identical battery modules. Thus, any number of battery units can be provided in the main battery system and an appropriate number or also exactly one battery unit of identical design can be provided in the emergency battery system. This brings great advantages, since in particular the nominal voltages of the individual battery systems are likewise automatically identical. This means that an adjustment and the provision of inverter or rectifier functions are no longer necessary.

It is furthermore advantageous if, in a battery device according to the invention, the main battery system and the emergency battery system are arranged in a common battery housing. This also applies in particular to the arrangement of the two switches, i.e. of the emergency switch and of the main switch. From the outside, the battery device can thus be recognised as a compact unit. The battery device can be pre-installed in such a common battery housing cost-effectively and easily, so that a single construction unit in the form of a common battery housing is available for the final installation in the vehicle. In particular, all switching functionalities as well as the complete control intelligence are likewise arranged within this common battery housing.

A further advantage can be achieved if, in a battery device according to the invention, the emergency switch is reduced in design in relation to the main switch at least with regard to one of the following parameters:
electrical load limit
costs
weight
electrical fuse protection.

The above list is not intended to be definitive. It can clearly be seen here that a reduction in at least one, in particular several of the above parameters, which determine the costs and the weight and the total necessary expenditure for the emergency switch, can be achieved, and thus an optimisation of the battery device. The fact that the emergency battery system is designed to be correspondingly smaller than the main battery system makes it possible also to make the emergency switch correspondingly smaller. This clearly distinguishes the core concept according to the invention of an asymmetric design of the emergency battery system and main battery system from a simple duplication of a main battery system.

It is also advantageous if, in a battery device according to the invention, the emergency battery system is arranged adjacent to or substantially adjacent to a common control module of the emergency battery system and of the main battery system, in particular closer than the main battery system. In other words, shorter electrical lines and shorter control lines can be provided between the emergency battery system and the control module. Reduced cable cross-sections are also possible here, since correspondingly less power needs to be output from the emergency battery system.

In addition, these reduced cable cross-sections also lead to less weight and lower costs for a battery device according to the invention.

In addition, it is advantageous if, in a battery device according to the invention, the main battery system and the emergency battery system have a common contact section for a parallel-wired connection to a consumer. As has already been explained, in regular use the main battery system and emergency battery system are connected with one another in parallel in an electrical circuit. The common contact section also allows a corresponding battery device according to the invention to be used with existing electrical connection situations for the consumers in a vehicle. In particular, this common contact section is formed as part of a common battery housing and/or integrated into such a common battery housing. This common contact section is preferably designed as a common plug connector and can for example be arranged electrically downstream of the emergency switch and the main switch.

It brings further advantages if, in a battery device according to the invention, a common control module is provided for the main battery system and the emergency battery system, wherein in particular at least one common additional control module is provided for the main battery system and the emergency battery system. In other words, a redundant design is provided here in order to be able to retain control over the battery device even in the event of a defect in the control module or in the additional control module. The control with the aid of the control module and/or the additional control module allows a charging, a discharging, but also a balancing of the main battery system and the emergency battery system.

The subject matter of the present invention also includes a method for monitoring a battery device according to the present invention, having the following steps:
detecting a defect in a battery unit
detecting an assignment of the defective battery unit to the main battery system or the emergency battery system
disconnecting the main battery system or the emergency battery system based on the assignment of the defective battery unit.

Thus, according to the invention, a defect can now not only be detected in a battery unit, but also assigned to the main battery system or the emergency battery system.

In a final step, the part of the battery device in which the defect has been localised and assigned is disconnected from the electrical circuit in a manner according to the invention. Thus, a method according to the invention brings the same advantages as have been explained in detail with regard to a battery device according to the invention.

It is also advantageous if, in a method according to the invention, in the case of an assignment of the defective battery unit to the main battery system the power output of the emergency battery system is limited. This means that a minimum mobility, for example a minimum range, can be achieved even if the emergency battery system can guarantee a reduced power output due to its reduced size. For example, it is conceivable for the reduction to be based on the speed, the acceleration, the cooling effort or the reduction of non-prioritised consumers.

This further protects the functionality according to the invention of the “limp home” function of the vehicle.

It can also be advantageous if, in a method according to the invention, in normal operation of the battery device the main battery system and the emergency battery system are at least at times operated together. This should be understood to means that in a normal operating state both the main battery system and the emergency battery system provide the power output together. This also applies when charging the battery device, so that the main battery system and the emergency battery system are at least at times charged together. Preferably, however, an embodiment can be provided here which serves to protect the emergency functionality. Thus, a common lower limit can be specified below which the emergency battery system should not fall with regard to its state of charge (SOC). As soon as the common state of charge of the main battery system and emergency battery system reaches this state during driving operation, i.e. during discharge, the emergency battery system is disconnected by the emergency switch and only the main battery system guarantees the supply of electrical power. In a subsequent charging cycle, the main battery system alone is first charged to this defined lower limit, so that only when an identical or substantially identical state of charge between main battery system and emergency battery system is reached is the emergency battery system connected via the emergency switch and the common charging process continues. The at least temporary joint operation with regard to states of charge and states of discharge of the two battery systems means that both the use and the ageing of both battery systems can be made available together.

Further advantages, features and details of the invention result from the following description in which exemplary embodiments of the invention are described in detail with reference to the drawings. The features mentioned in the claims and in the description can be essential to the invention individually or in any combination. In each case schematically:

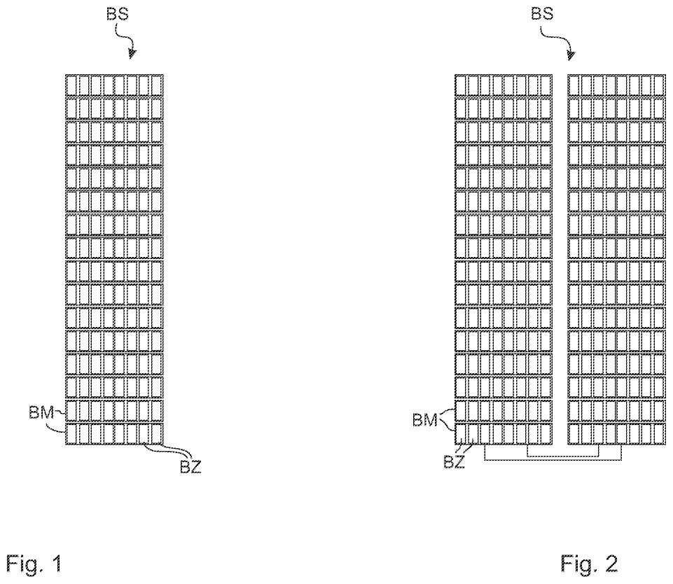

FIG. 1 shows an exemplary embodiment of a battery unit according to the invention,

FIG. 2 shows an exemplary embodiment of two adjacent battery units,

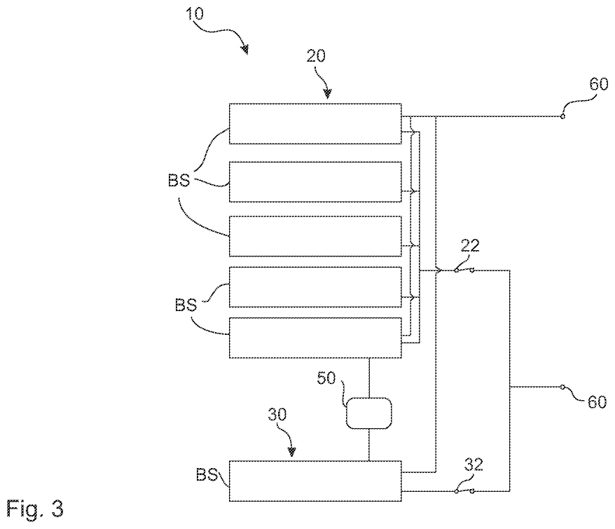

FIG. 3 shows a schematic representation of a battery device according to the invention,

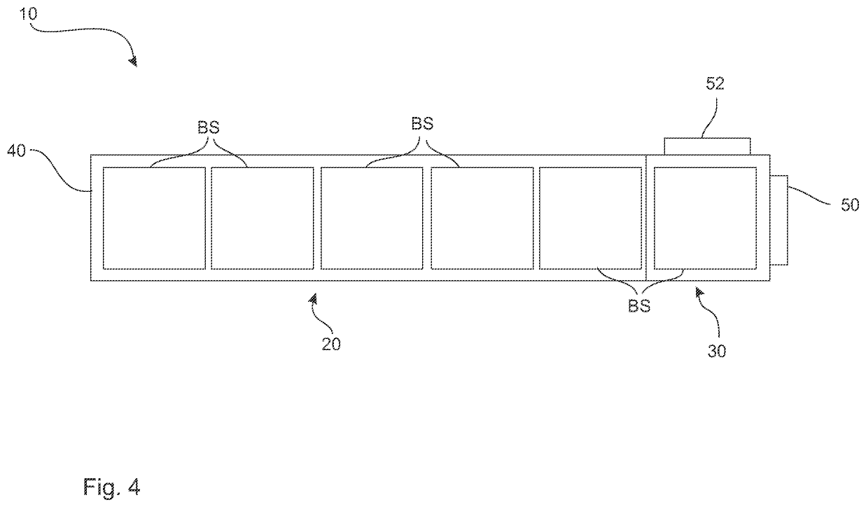

FIG. 4 shows a further representation of a battery device according to the invention,

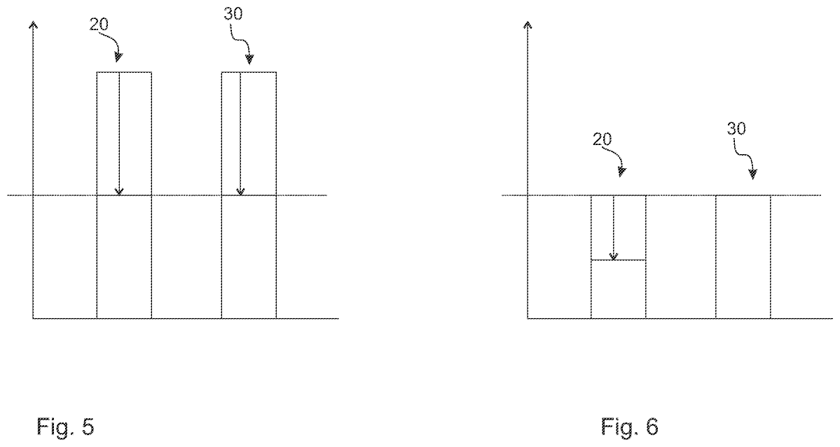

FIG. 5 shows a situation during discharging,

FIG. 6 shows an advanced situation during discharging,

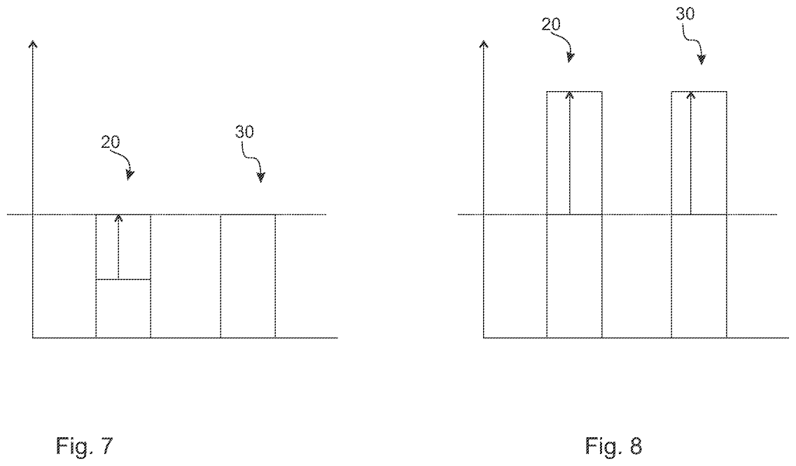

FIG. 7 shows a situation during charging and

FIG. 8 shows an advanced situation during charging of the battery device.

FIGS. 1 and 2 show, schematically, how a battery unit BS can fundamentally be structured. This can be an individual battery unit BS according to FIG. 1. In this case a plurality of battery modules BM is arranged side by side to form the battery unit BS. Each of the individual battery modules BM is designed with a plurality of battery cells BZ which are connected with one another electrically. FIG. 2 shows a battery unit BS which represents a duplication of the embodiment in FIG. 1. It is shown here how the number of battery cells BZ and battery modules BM can be increased accordingly in series connection.

FIG. 3 shows schematically how a battery device 10 can be structured. It can clearly be seen here that a main battery system 20 and an emergency battery system 30 are asymmetrical in design. The main battery system 20 consists of five battery units BS which are arranged parallel to one another. The emergency battery system 30 consists of only a single battery unit BS. Preferably, all battery units BS, i.e. those of the main battery system 20 and that of the emergency battery system 30, are of identical design. A fundamental distinction can now be made between two defect scenarios. These involve, on the one hand, a defect in the emergency battery system 30, i.e. in this at least one or exactly one battery unit BS.

This leads to a detection of the defect and a localisation by the control module 50, so that the emergency battery system 30 can then be disconnected via the emergency switch 32. In such a case, there is still enough electrical capacity available in the main battery system 20 to ensure a residual mobility for the vehicle.

Naturally, in the case of an embodiment according to FIG. 3 for example, a redundant design of the switches 22 and 32 can also be provided. Thus, such a second switch 22 and/or 32 could be provided in each connection line of the main battery system 20 and/or of the emergency battery system 30 in order to create redundancy. It is also conceivable for one or more electrical fuses to be arranged in one or more of these connection lines.

However, if there is a defect within the main battery system 20, i.e. in at least one of the battery units BS of the main battery system 20, this can also be detected by the control module 50 and assigned accordingly. Following assignment, the main battery system 20 is disconnected from the electrical circuit by the main switch 22. However, in contrast to known solutions, the residual electrical capacity in the emergency battery system 30 is still available to ensure a residual mobility for the vehicle. In both defect scenarios, the corresponding electrical capacity is applied to common contact sections 60.

FIG. 4 shows another exemplary embodiment of a battery device 10 according to the invention. In this case, all battery units BS of the main battery system 20 and of the emergency battery system 30 are integrated in a common battery housing 40. It can also clearly be seen here that the battery unit BS of the emergency battery system 30 is arranged on the far right and thus in immediate proximity to the control module 50, as well as to a redundant additional control module 52. The emergency battery system 30 is thus arranged closer to the control module as well as to the additional control module 52 than is the case for the battery units BS of the main battery system 20.

FIGS. 5 and 6 show one possibility of a discharge situation. From a fully charged state of the main battery system 20 and emergency battery system 30, a joint and thus parallel discharge takes place according to FIG. 5. As soon as a defined threshold is reached, in order to ensure a residual mobility in the event of a defect only the main battery system 20 can be used to provide drive power on the basis of this threshold. The emergency battery system 30 is disconnected from the circuit, in particular by the emergency switch 32, and therefore remains at this residual state of charge. Following discharge, the embodiment shown in FIGS. 7 and 8 can be carried out during a charging situation. Thus, according to FIG. 7, the state of charge of the main battery system 20 is first replenished until it corresponds or substantially corresponds to the state of charge of the emergency battery system 30. Only then is the emergency battery system 30 reconnected to the charging process, for example via the emergency switch 32, so that according to FIG. 8 a joint charging of the main battery system 20 and emergency battery system 30 takes place.

The above explanation of the embodiments describes the present invention exclusively in the context of examples. Naturally, individual features of the embodiments can, where technically expedient, be freely combined with one another without departing from the scope of the present invention.

### REFERENCE SIGNS

10 battery device
20 main battery system
22 main switch
30 emergency battery system
32 emergency switch
40 battery housing
50 control module
52 additional control module
60 contact section
BS battery unit
BM battery module
BZ battery cell

1. Battery device (10) for a vehicle, having a main battery system (20) with at least two battery units (BS) and an emergency battery system (30) with at least one battery unit (BS), wherein the main battery system (20) has more battery units (BS) than the emergency battery system (30), wherein the main battery system (20) and the emergency battery system (30) furthermore have the same nominal voltage and are electrically connected in parallel with one another, and the main battery system (20) has a main switch (22) for disconnecting the main battery system (20) and the emergency battery system (30) has an emergency switch (32), separate from the main switch (22), for disconnecting the emergency battery system (30).

2. Battery device (10) according to claim 1, characterised in that the emergency battery system (30) has exactly one battery unit (BS).

3. Battery device (10) according to claim 1, characterised in that the battery units (BS) of the main battery system (20) and the battery units (BS) of the emergency battery system (30) are electrically identical or substantially identical.

4. Battery device (10) according to claim 1, characterised in that the main battery system (20) and the emergency battery system (30) are arranged in a common battery housing (40).

5. Battery device (10) according to claim 1, characterised in that the emergency switch is reduced in design in relation to the main switch (22) at least with regard to one of the following parameters:
electrical load limit
costs
weight
electrical fuse protection.

6. Battery device (10) according to claim 1, characterised in that the emergency battery system (30) is arranged adjacent or substantially adjacent to a common control module (50) of the emergency battery system (30) and of the main battery system (20), in particular closer than the main battery system (20).

7. Battery device (10) according to claim 1, characterised in that the main battery system (20) and the emergency battery system (30) have a common contact section (60) for a parallel-connected connection to a consumer.

8. Battery device (10) according to claim 1, characterised in that a common control module (50) is provided for the main battery system (20) and the emergency battery system (30), wherein in particular at least one common additional control module (52) is provided for the main battery system (20) and the emergency battery system (30).

9. Method for monitoring a battery device (10) with the features of claim 1, having the following steps:
detecting a defect in a battery unit (BS),
detecting an assignment of the defective battery unit (BS) to the main battery system (20) or the emergency battery system (30),
disconnecting the main battery system (20) or the emergency battery system (30) on the basis of the assignment of the defective battery unit (BS).

10. Method according to claim 9, characterised in that in the case of an assignment of the defective battery unit (BS) to the main battery system (20), the power output of the emergency battery system (30) is limited.

11. Method according to claim 9, characterised in that in normal operation of the battery device (10) the main battery system (20) and the emergency battery system (30) are at least at times operated together.
